(19) United States
(12) Patent Application Publication
(10) Pub. No.: US 2007/0023078 A1
(43) Pub. Date: Feb. 1, 2007

(54) Mobile vehicle having solar cell arrays for providing supplemental electric power

(76) Inventor: James Palladino, Winona Lake, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/193,770

(22) Filed: Jul. 28, 2005

(51) Int. Cl. H02N 6/00

(52) U.S. Cl. 136/244

(57) ABSTRACT

Each of multiple solar cell arrays has a face oriented differently relative to the direction from which solar radiation is incident on a motor vehicle and a characteristic voltage/current output correlated with the intensity of incident solar radiation for converting the incident solar radiation into electricity. A processor processes data related to the voltage/current output from each array as the array is converting solar radiation into electricity for selectively connecting the arrays in configurations correlated with the intensity of incident solar radiation. The arrays provide supplemental electricity to keep the vehicle battery charged preventing certain small loads from draining the battery while the vehicle is parked with its engine off. The arrays can be advantageously mounted in outside rearview mirror assemblies.

### FIELD OF THE INVENTION

This invention relates to novel systems, devices, and methods for providing mobile vehicles, such as motor vehicles, with the ability to convert incident solar radiation into electricity that can supplement on-board electrical energy sources, such as a battery or battery bank.

### BACKGROUND OF THE INVENTION

When a motor vehicle is parked with its engine off, certain devices in the electrical system continue to draw small amounts of current. As long as the engine is re-started within some limited amount of time, the battery retains sufficient charge to enable the engine to be cranked and started. Occasionally a vehicle will remain parked for a sufficiently long time without its engine being started that the battery is drained to the point where it cannot crank the engine. Consequently, systems and devices that could preclude that possibility would be desirable.

A vehicle that is parked outside in a location where it has exposure to the sun for significant portions of a day can utilize solar energy as a supplemental power source if it is equipped with solar cells for converting solar radiation into electricity.

U.S. Pat. No. 6,525,507 discloses a solar system for a motor vehicle that uses solar power to charge a condenser for operating a cooling fan. U.S. Pat. No. 6,812,854 discloses an inside mirror having batteries that may be recharged by solar cells. U.S. Pat. No. 6,239,701 discloses a vehicle locator device having a battery/solar powered strobe light. Other U.S. patents involving the application of solar power to motor vehicles include: U.S. Pat. Nos. 4,277,737; 4,327,316; 4,786,851; 4,871,959; 4,911,257; 5,089,764; 5,315,227; 5,905,356; 5,986,429; and 6,476,315.

### SUMMARY OF THE INVENTION

The present invention relates to novel systems, devices, and methods for utilizing solar energy to provide supplemental electricity for a mobile vehicle, especially a motor vehicle when parked for an extended period of time with its engine shut off.

According to a first generic aspect, the invention relates to an energy conversion system that is on-board a mobile vehicle for converting incident solar radiation into electricity for use in an electrical system of the vehicle. The energy conversion system comprises multiple solar cell arrays, each of which has a face oriented differently relative to the direction from which solar radiation is incident on the vehicle. Each array comprises a characteristic voltage/current output correlated with the intensity of incident solar radiation for converting the incident solar radiation into electricity.

A processor processes data related to the voltage/current output from each array as the arrays are converting solar radiation into electricity for selectively connecting the arrays in configurations correlated with the intensity of solar radiation incident on the vehicle.

According to another generic aspect, the invention relates to a motor vehicle comprising an electrical system comprising one or more batteries providing electricity and an engine that is turned on and off by operation of a switch in the electrical system.

An on-board energy conversion system converts incident solar radiation into electricity for use in the electrical system. The energy conversion system comprises one or more solar cell arrays collectively providing a characteristic voltage/current output correlated with the intensity of incident solar radiation for converting the incident solar radiation into electricity.

The electrical system has one or more loads that draw electricity when the switch is off. The one or more arrays are configured to provide an open circuit voltage for overcoming the charge acceptance voltage of the one or more batteries when the intensity of solar radiation incident on the one or more arrays is greater than a defined minimum intensity but less than a maximum intensity, and for delivering, with the switch off, sufficient electric current for the one or more loads when the intensity of solar radiation incident on the one or more arrays is greater than the defined minimum.

According to still another generic aspect, the invention relates to an energy conversion system that is on-board a mobile vehicle for converting solar radiation into electric power for use in an electrical system of the vehicle that comprises one or more batteries providing electricity for the electrical system.

The energy conversion system comprises a solar cell array that converts incident solar radiation into electricity, that is disposed in an outside rearview mirror assembly of the vehicle, and that is electrically connected to the electrical system to supply electricity to the electrical system for aiding in maintaining state of charge of the one or more batteries.

According to still another generic aspect, the invention relates to an outside rearview mirror assembly for a motor vehicle comprising a mirrored surface for providing a driver of the vehicle with a field of view rearward of the vehicle, a solar cell array for converting incident solar radiation into electricity, and a connection for connecting the array to supply electricity to an electrical system of the vehicle.

According to a further generic aspect, the invention relates to an energy conversion method on-board a mobile vehicle for converting incident solar radiation into electricity for use in an electrical system of the vehicle.

The method comprises processing data related to the voltage/current output of multiple solar cell arrays, each of which has a face oriented differently relative to the direction from which solar radiation is incident on the vehicle and comprises a characteristic voltage/current output correlated with the intensity of incident solar radiation, for converting the incident solar radiation into electricity, and selectively connecting the arrays in configurations correlated with the intensity of solar radiation incident on the vehicle.

The foregoing, along with further features and advantages of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1 is a schematic diagram of a first embodiment of the present invention containing multiple solar cell arrays.

FIG. 2 is a graph illustrating characteristics of a representative solar cell array normalized for both voltage and current.

FIG. 3 is a schematic diagram illustrating a first configuration of multiple solar cell arrays.

FIG. 3A is a graph similar to FIG. 2 showing the characteristics of the array configuration of FIG. 3.

FIG. 4 is a schematic diagram illustrating a second configuration of multiple solar cell arrays.

FIG. 4A is a graph similar to FIG. 3A showing the characteristics of the array configuration of FIG. 4.

FIG. 5 is a schematic diagram of a second embodiment of the present invention containing multiple solar cell arrays.

FIG. 6 is a top plan view of a motor vehicle containing the second embodiment.

FIG. 7 is a front elevation view of FIG. 6.

FIG. 8 is a left side elevation view of the vehicle of FIG. 6.

FIG. 9 is an elevation view in the direction of arrows 9-9 in FIG. 6 on a larger scale.

FIG. 10 is a left side elevation view of FIG. 9.

FIG. 11 is a right side elevation view of FIG. 9.

FIG. 12 is a top plan view of FIG. 9.

FIG. 13 is a schematic graphical diagram illustrating solar radiation incident on a vehicle that is parked facing north over the course of a day at about 45° north latitude in winter.

FIG. 14 is a schematic graphical diagram illustrating solar radiation incident on a vehicle that is parked facing north over the course of a day at about 45° north latitude in spring/fall.

FIG. 15 is a schematic graphical diagram illustrating solar radiation incident on a vehicle that is parked facing north over the course of a day at about 45° north latitude in summer.

FIG. 16 is a schematic graphical diagram illustrating solar radiation incident on a vehicle that is parked facing north over the course of a day at about 33.5° north latitude in winter.

FIG. 17 is a schematic graphical diagram illustrating solar radiation incident on a vehicle that is parked facing north over the course of a day at about 33.5° north latitude in spring/fall.

FIG. 18 is a schematic graphical diagram illustrating solar radiation incident on a vehicle that is parked facing north over the course of a day at about 33.5° north latitude in summer.

FIG. 19 is a chart of certain data related to power output of an array.

FIG. 20 is a chart of certain solar energy data.

FIG. 21 is a schematic diagram of another embodiment of the present invention.

### DESCRIPTION OF THE PREFERRED EMBODIMENT

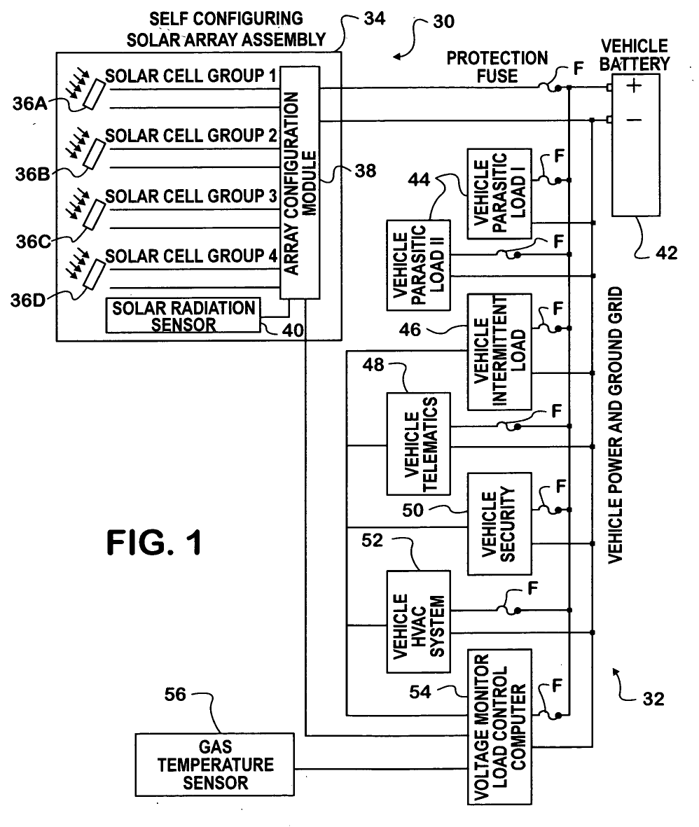

FIG. 1 shows a portion of a motor vehicle, such as a truck, comprising a first embodiment of the inventive energy conversion system 30 in association with the vehicle's electrical system 32. The truck electrical system may be a nominal 12 volt DC system that has one or more storage batteries. When the engine is running, an engine-driven alternator supplies current for system loads and keeps the battery or batteries charged.

When the engine is not running, certain loads continue to draw battery current. When the ignition switch that turns the engine on and off is in “off” position, only loads that have direct connection to the battery draw current. Generally that current draw is fairly small. When the ignition switch is in “on” position without the engine running, additional loads may draw battery current. Those additional loads will increase the rate at which battery state of charge diminishes. If battery state of charge diminishes to the point where battery voltage is insufficient to crank the engine at engine starting, the engine will not start.

A truck may occasionally be parked for an extended amount of time during which the engine is not re-started. Even the fairly small loads that are directly on the battery during this time may deplete battery charge to a point where the engine cannot be re-started. The inventive energy conversion systems that are disclosed herein can provide supplemental current for at least extending the allowable time that a vehicle can be parked without losing battery charge to the point where the engine cannot be re-started, and ideally extend the time indefinitely so that a parked vehicle can always be re-started.

Energy conversion system 30 comprises a self-configuring solar array assembly 34 that comprises multiple solar cell arrays (solar cell groups), four such arrays 36A, 36B, 36C, 36D in this example. Assembly 34 further comprises an array configuration module 38, sometimes referred to as a configuration, and a solar radiation sensor 40.

Electrical system 32 comprises one or more batteries 42 and various loads that include one or more parasitic loads 44, one or more intermittent loads 46, a telemetric system 48, a security system 50, and a heating, ventilating, air conditioning system (HVAC) 52. A voltage monitor load control computer 54 is associated with certain loads, 46, 48, 50, 52 in this example, and with configuration 38. A cab temperature sensor 56 is also associated with monitor 54.

Electrical system 32 comprises a power and ground grid 58 that places the various loads and monitor 54 across positive and negative terminals of battery or batteries 42. Configuration 38 is also placed on grid 58. Overload protection devices, such as fuses F, prevent shorts in any of the devices on the grid from shorting out the battery.

Arrays 36A, 36B, 36C, 36D are arranged on the vehicle at various locations where solar radiation can be incident on them. They may be identical in size or different in size. They may face in the same direction or in different directions. Configuration 38 functions to configure the connection of the arrays to grid 58 according to the intensity of incident solar radiation as measured by sensor 40.

Configuration 38 comprises electrically controlled switches, transistors for example, that selectively connect the individual arrays in ways that create various configurations that present different voltage/current output characteristics to grid 58. This is believed to be an effective way to associate the arrays with the grid because array size can be optimized, and the array can operate at a higher efficiency because relatively less efficient DC-to-DC conversion is unnecessary.

Configuration 38 may have a self-contained processor that controls the manner in which the individual arrays are connected based on processing of data from sensor 40 to operate the controlled switches, or alternatively the controlled switches in the configuration may be controlled by a remote processor that is part of electrical system 32 using data from sensor 40.

Parasitic loads 44 shown in FIG. 1 represent memory in certain on-board electronic devices that require some electric current to maintain stored data. Such current requirements are relatively small, typically <10 milliamps each, but are always present. Array assembly 34 is sized to meet the load requirements of such devices, and for example, may be designed to convert incident solar radiation for a constant 50 milliamp parasitic load.

Intermittent loads may also be powered by converted solar radiation. Computer 54 monitors conditions in electrical system 32, including battery state of charge, and prioritizes and schedules activation of various intermittent loads 46 when the ignition switch is off. Additional intermittent loads are telemetric system 48, security system 50, and HVAC system 52. Array assembly 34 therefore can supply electric power for continuous lower current (as a primary function) or intermittent higher current (as a secondary function) while the vehicle engine is off and the alternator is not keeping the battery charged.

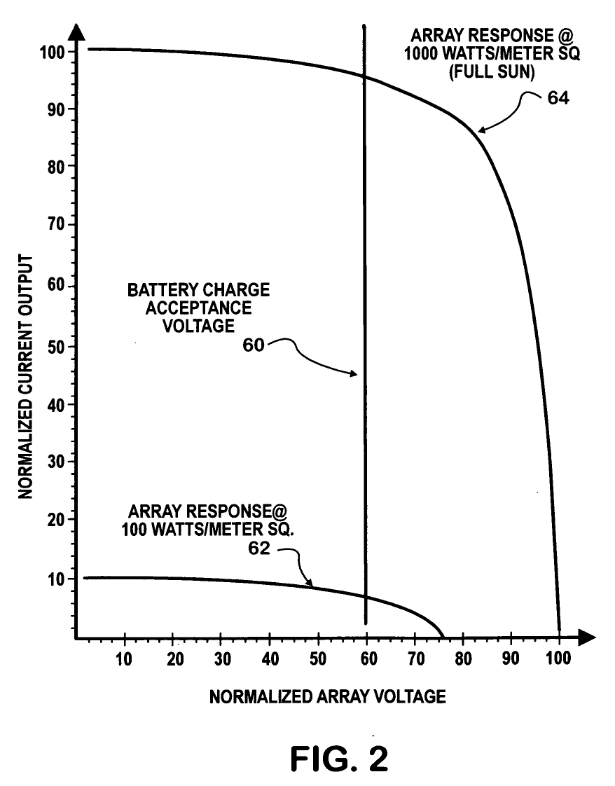

The solar cells in each array are configured to supply an open circuit voltage that will overcome the battery charge acceptance voltage at some intensity of incident solar radiation. Because the magnitude of that open circuit voltage will change as the intensity incident solar radiation changes, it is appropriate to select an intensity that will enable the arrays to be effective to some degree during cloudy or overcast weather conditions. In the embodiments disclosed here, the arrays are sized to provide that voltage level when the intensity of incident solar radiation exceeds 100 watts per square meter. This allows the array to function on cloudy days. Intensity of incident radiation can become much greater and a representative response of a properly sized array is shown in FIG. 2.

Each array comprises a collection of individual solar cells. The voltage output of a cell varies with type, but is approximately 0.5 v. The peak current output of a cell depends on efficiency and size. A solar array is a collection of cells which are connected together in various series and parallel configuration to produce an assembly with the desired voltage and current rating. Typically, the configuration is fixed, and the array produces a voltage and current response similar to that shown in FIG. 2.

The horizontal axis of FIG. 2 is normalized voltage output, and the vertical axis, normalized current output. When the intensity of incident solar radiation exceeds the battery charge acceptance voltage represented by the line 60, current is delivered into the grid. At low intensity the deliverable current is relatively small, but at highest intensity (full sunlight), much larger current can be delivered. The line 62 illustrates array voltage/current output at incident intensity of 100 watts per square meter, and the line 62 illustrates array voltage/current output at incident intensity of 1000 watts per square meter.

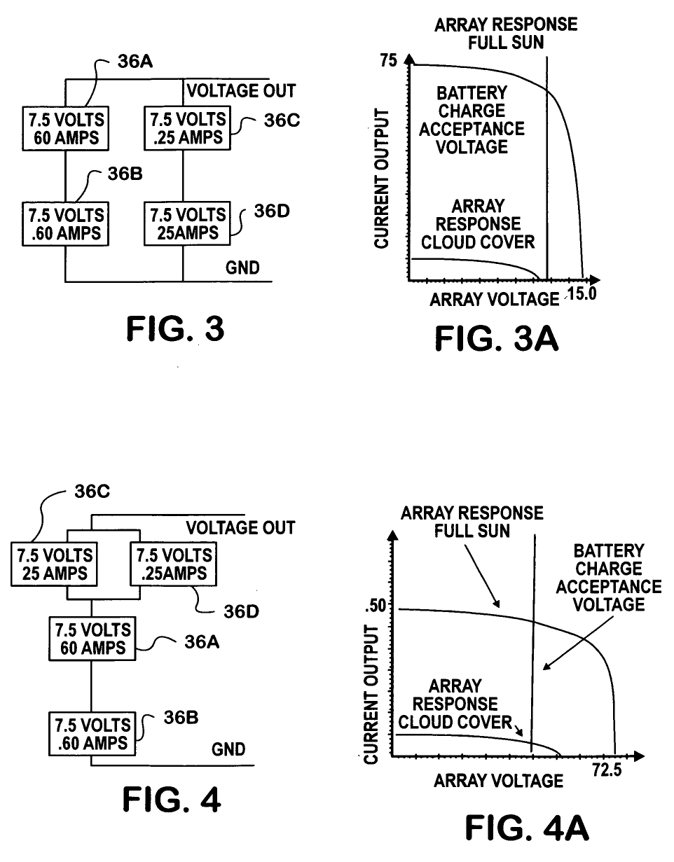

FIG. 3 illustrates a condition where configuration 38 has placed the arrays in a “parallel” configuration. It is in this configuration that array assembly 34 can most efficiently supply current during full sun conditions. The corresponding voltage/current characteristic is presented in FIG. 3A.

FIG. 4 illustrates a condition where configuration 38 has placed the arrays in a “series” configuration. It is in this configuration that array assembly 34 can most efficiently supply current during cloudy and overcast conditions. The corresponding voltage/current characteristic is presented in FIG. 4A.

By comparing FIGS. 3A and 4A, one can see that the configuration of FIG. 3 is incapable of overcoming the battery charge acceptance voltage during cloudy conditions, and hence is incapable of delivering current into the grid, while that of FIG. 4 can deliver current. And at full sun, the configuration of FIG. 3 can deliver more current than that of FIG. 4.

The maximum open circuit voltage for the configuration of FIG. 3 is 15.0 volts while that for FIG. 4 is 22.5 volts, and so because FIGS. 3A and 4A represent open circuit voltage of array assembly 34, it should be kept in mind that when the assembly is delivering current into the grid, the open circuit voltage will be forced to the grid voltage, which is typically around 12 volts DC in a 12 volt electrical system.

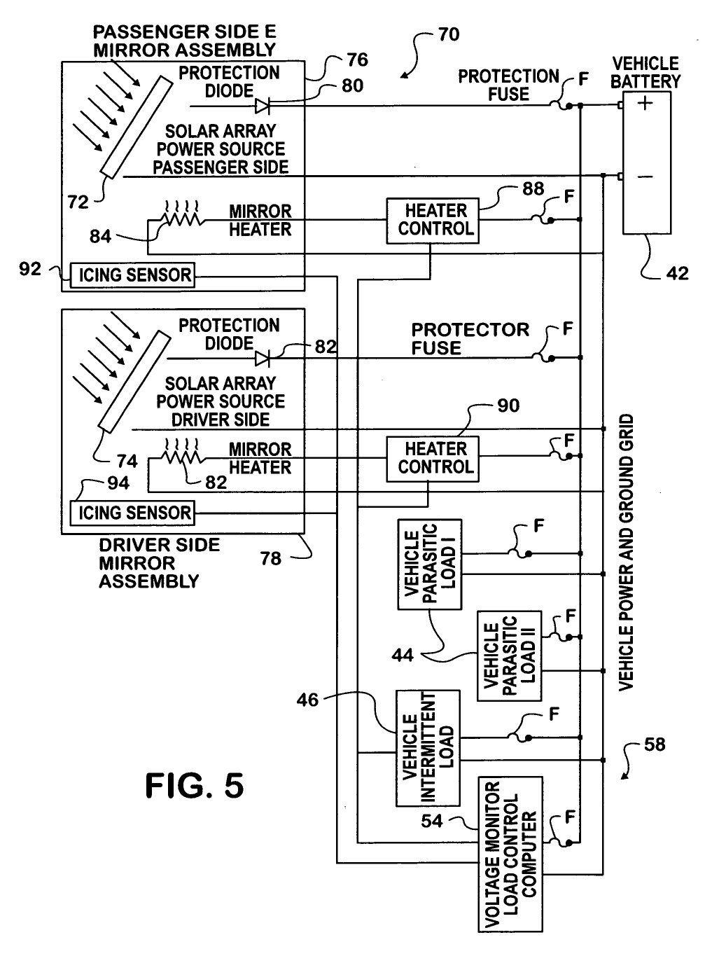

FIG. 5 discloses a second embodiment of energy conversion system 70 that comprises two separate solar cell arrays 72, 74, each integrated into a respective side view mirror assembly 76, 78 of a motor vehicle. These arrays can be connected in series or parallel configurations to provide power for continuous low current (as the primary function) or intermittent high current loads (as the secondary function) while the vehicle engine is off. FIG. 5 shows only the parallel connection.

The integration of an array into a mirror assembly provides considerable protection from environmental factors and reduces the possibility of poor solar performance due to blockage from snow, ice, dust, or other debris. Each array 72, 74 is mounted inside a respective mirror assembly shell and receives solar radiation through a lens integrated into the outer surface of the shell. The result is a multi-function assembly. The mirror shell protects the solar array from the environment, and the integrated lens allows solar radiation to enter the assembly. Part of this radiation is converted to electricity when it strikes the solar array. Another portion is converted to heat which is helpful in keeping the assembly clear of snow and ice, although the assembly may be provided with an electric heating element. Such a heating element can perform the dual function of melting snow and ice from 1) driver's and passenger's mirrors and 2) the solar lenses. The heater is typically used when the vehicle engine is running, but can also be activated for short periods when the engine is off.

In FIG. 5, the same elements that were described in connection with FIG. 1 are designated by the same reference numerals. Not all of the loads on the grid are shown in FIG. 5. Each array 72, 74 is protected not merely by a fuse F, but also by a respective diode 80, 82. Each assembly also comprises a respective electric heater 84, 86 for heating both the mirror and the lens as mentioned above. Heating provided by the heaters is controlled by a respective heater control 88, 90, that is remote from the respective mirror assembly. Each assembly further comprises a respective icing sensor 92, 94 that signals computer 54 when there is a need for the respective heater 84, 86 to be activated. The computer then processes the request and may initiate de-icing. As will be more fully explained later, the nature of the de-icing may depend whether the vehicle engine is or is not running.

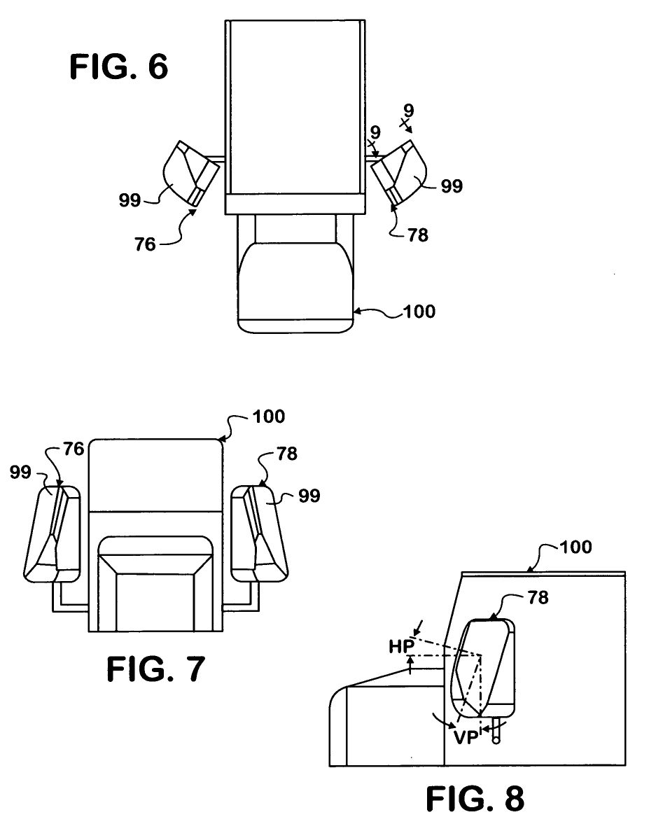

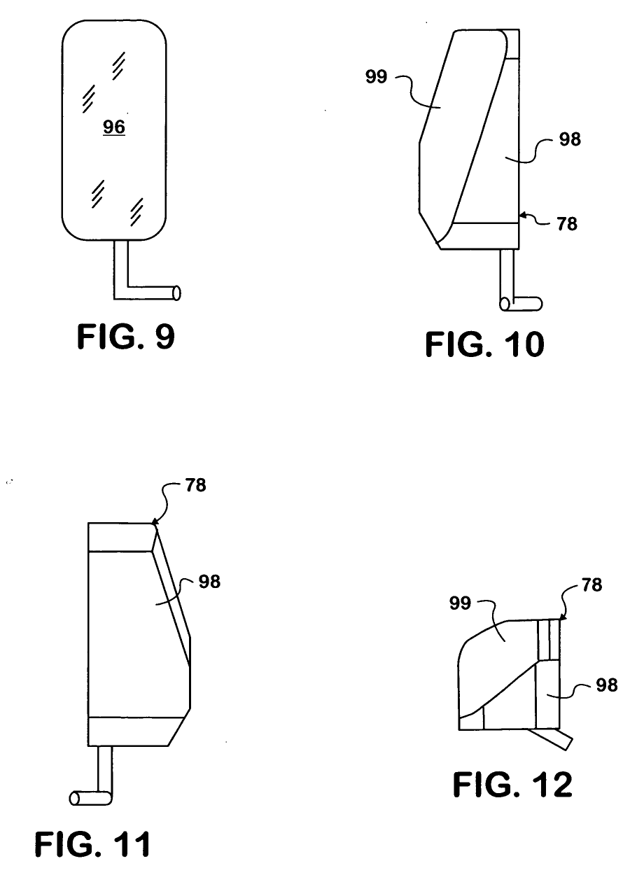

FIGS. 6-12 illustrate more detail of mirror assemblies 76, 78. In addition to housing each array 72, 74, each mirror assembly 76, 78 also houses a rearview mirror 96 having a mirrored surface. Respective shells 98 serve to house the arrays and the rearview mirrors. A respective protective lens 99 that is transparent to solar radiation is disposed in association with the respective shell 98 in covering relation to the respective array 72, 74. Each shell 98 encloses the respective array, the respective heater 84, 86, and the respective icing sensor 92, 94.

Mirror assembly 76 is mounted on the right side of the vehicle, and mirror assembly 78, on the left. Hence they are essentially symmetrically opposite about a horizontal fore-aft centerline of the vehicle. Each rearview mirror 96 is oriented so that the driver of the vehicle can have a rearward field of view when looking at it. The mirrors 96 are adjustable within shells 98 to secure a desired field of view, and in that regard may be motorized to allow the driver to position them remotely when seated in the driver's seat. The arrangement of mirror assemblies 76, 78 on the vehicle and the orientations of arrays 72, 74 are important aspects of the invention in enabling a parked vehicle to keep battery charge.

Each array has a face that faces generally opposite the direction in which the respective mirror 96 faces. The array face is pitched both horizontally and vertically, the example here showing a pitch of about 20° from vertical and a pitch of about 25° from horizontal when mounted on the vehicle. If the mirror assemblies are mounted on the side doors that swing open and closed, it is understood that the array orientations just described assume that both doors are closed. Hence it is those orientations that are present in FIGS. 6, 7, and 8 which show a truck 100, with the mirror assemblies relatively enlarged for purposes of clarity. In FIG. 8, VP is the vertical pitch and HP is the horizontal pitch.

Another way to describe the array orientation is with reference to an imaginary line that is normal to the face of the array. Each array face may be said to face in a direction that is oblique to an imaginary vertical line passing through the array, oblique to an imaginary horizontal line passing through the array parallel to the fore-aft direction in the vehicle, and oblique to an imaginary horizontal line passing through the array perpendicular to the fore-aft direction in the vehicle.

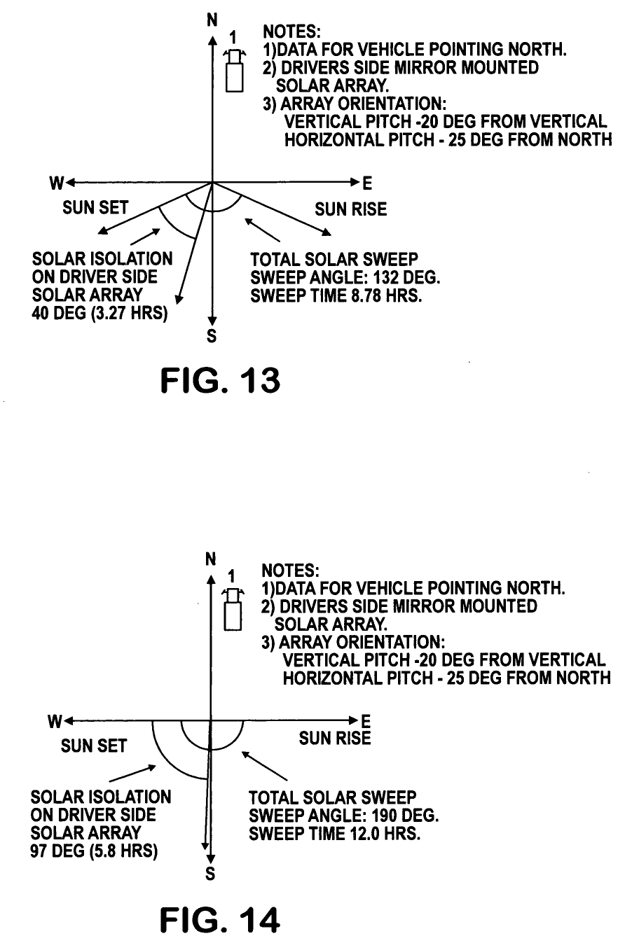

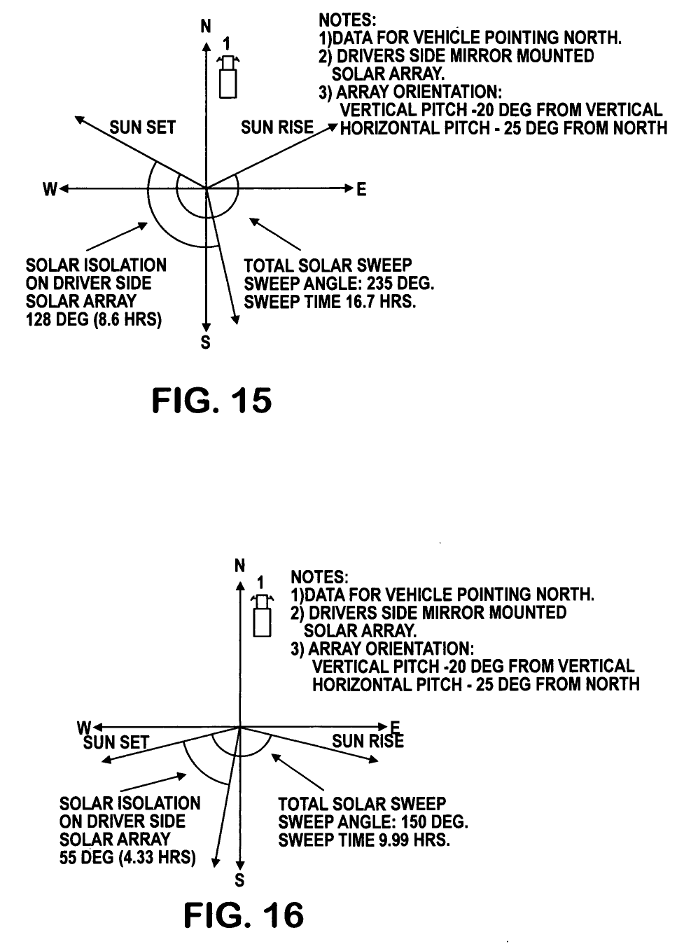

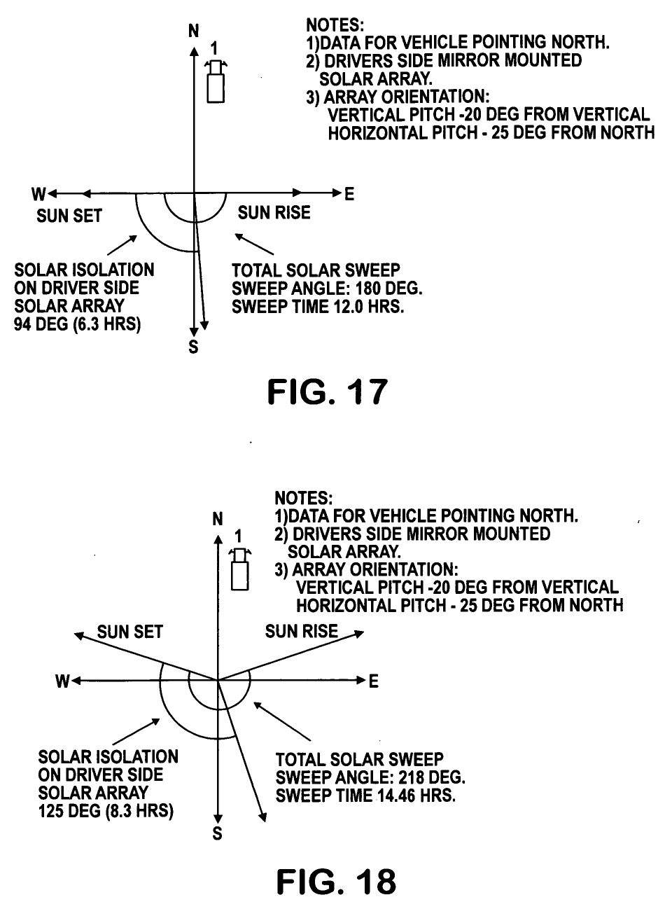

The array orientations on truck 100 produces a daily window of exposure for each array that depends on the orientation of the truck. The arrangement of solar arrays mounted at opposing angles allows for access to direct solar radiation for several hours each day regardless of vehicle orientation. The “worst case” orientation will occur when the vehicle is pointed north. FIGS. 13-18 and the explanatory notations accompanying them show the amount of time that an array will have direct solar exposure with the vehicle pointed north for different times of year and different latitudes in the northern hemisphere.

As the arrays convert solar radiation into electricity, that electricity is fed into grid 58. Heaters 84, 86 can warm the interior of the shells with heat also being conducted to the exterior surface. A heater can be turned on by the driver when the vehicle is running or by computer 54 when the engine is off. Sensors 92, 94 can sense moisture and temperature and send a de-icing request to computer 54 that then processes the request and may initiate a short de-icing cycle if the proper conditions exist (i.e. enough battery charge).

The inventive systems are designed to operate under different prevailing ambient conditions, which may be classified generally as either as cool and cloudy, or as hot and sunny. During either type of prevailing condition, the primary function of providing supplemental power for operating low current loads without depleting battery charge can be accomplished. The arrays are designed such that the open circuit voltage remains above the charge acceptance voltage of the batteries even during cloudy conditions so that the arrays deliver supplemental current to the grid. The systems eliminate the need for energy conversion (DC to DC converters) or auxiliary storage. By keeping the battery or batteries at a high state of charge, battery cycling and battery stress are reduced.

During hot sunny days, considerably more power is required for cab cooling via HVAC system 52, but the inventive systems can supply power under that condition too because the intensity of incident solar radiation is also greater. Cab temperature sensor 56 in FIG. 1 signals temperature inside the truck cab. When the temperature rises to a point where some ventilation of the cab interior is appropriate, computer 54 operates a ventilation fan that can provide some ventilating to relieve the temperature. Because a motor is used to ventilate the cab, the current draw is much larger than the continual draw of the parasitic loads. Hence, such ventilation is allowed only intermittently.

The loads for which the arrays may be considered as two distinct types, 1) low power continuous loads (less than 0.12 watts for example) and 2) high power controllable loads (greater than 0.12 watts for example). In addition to those already mentioned, the low power loads may include devices such as clocks and devices which have two modes of operation (sleep or active). Devices in sleep mode retain active memory and monitor sensor inputs. The controllable (active) loads include telemetric system 48, security system 50, and HVAC system 52.

The inventive systems function to power these load types both directly and indirectly. The arrays provides direct power to low level loads during daylight hours when the arrays are active and can supply power in excess of that required for the low level loads. The excess power provides additional charge to the vehicle battery or batteries. When the arrays are unable to supply all the required power, the deficiency is reclaimed from the battery or batteries.

Active loads are controllable and can be activated (or made inactive) by human intervention or intervention of the vehicle's computer. In some cases the solar arrays will not be capable of supplying power to an active load continuously. When the ignition switch is off however, most active loads can be operated intermittently and still satisfy the requirements of the vehicle, in which case the arrays can supply power for intermittent occasional operation of active loads with the deficiency being supplied from the vehicle battery or batteries functioning as a power reservoir.

When the engine is off, the vehicle's computer can be used to calculate battery state of charge, estimate active loads, and measure ambient temperature. In this way, the computer can determine which loads can be safely turned on and for how long.

The vehicle security system 50 is active when the ignition switch is off. The inventive systems provide power for this function which operates in low and high power modes. In the low power mode (a majority of the time), the system scans various sensors for abnormal conditions. When an abnormal condition occurs, the security system becomes active for a short time to handle the condition.

The function of telemetric system 48 is to acquire information concerning the vehicle and transmit the information to a central base station. Telemetric can operate both when the engine is running and off the inventive systems supply power for telemetric when the ignition switch is off.

Control of telemetric system 48 is accomplished using computer 54 to schedule periodic telematic transmissions, which is often once a day. Therefore, the average power consumption required for this function is within the capabilities of the arrays.

Cab cooling is desirable to reduce cab interior temperature during periods of high solar loading. This function takes significant power and could not effectively be accomplished unless a power source is available. The solar array provides a good source since this is the time of peak array output.

The cab cooling function is accomplished by controlling equipment typically supplied with the vehicle. These components are mostly found in HVAC system 52 and include mode control doors, fan, and a HVAC controller.

The cooling cycle is controlled by the vehicle central computer, which monitors the system and controls the cooling cycle. The process is initiated by a cab cooling request which is generated when the temperature of a cab crosses a programmed setpoint. After this the computer reads the solar radiation sensor and calculates the amount of power available for cab cooling. The computer will cycle the cooling fan on and off using a low speed setting. During on times, some of the required power may be extracted from the batteries, but they will be replenished during fan off times. The computer will adjust the fan duty cycle so that the average power required does not exceed the power available through the solar array or arrays. A typical on/off cooling cycle may be 120 seconds long with the fan on for 12 seconds (10% duty cycle). The system is independent of the method used to control fan speed, and will work with any HVAC system which uses one of the common methods (resistive element, PWM, linear power module, etc).

For a vehicle having one or more arrays totaling an area of 0.10 square meter and a conversion efficiency of 12%, the average daily power output can be calculated for various geographic locations. Two sample locations are used as examples for calculating power output, 1) Saint Paul, Minnesota (45° North latitude), and 2) Phoenix, Ariz. (33.5° North latitude). For these two locations, the average daily incident solar energy per square meter, as published by NASA, is shown in FIG. 20.

In the embodiment of FIG. 5, the size of each array 72, 74 is approximately 0.05 square meter. Direct sunlight produces approximately one kilowatt of energy per square meter. The amount of energy expected from each mirror assembly per hour of incident solar radiation is:

1 kw-hr X AREA (0.05) X Efficiency (0.12)=6 watt-hrs. Spreading this over a 24 hr period provides average power of 0.25 watts. Dividing by an assumed battery voltage of 13.0 volts yields an average delivered current of 19.2 milliamps per kw-hr of insolation.

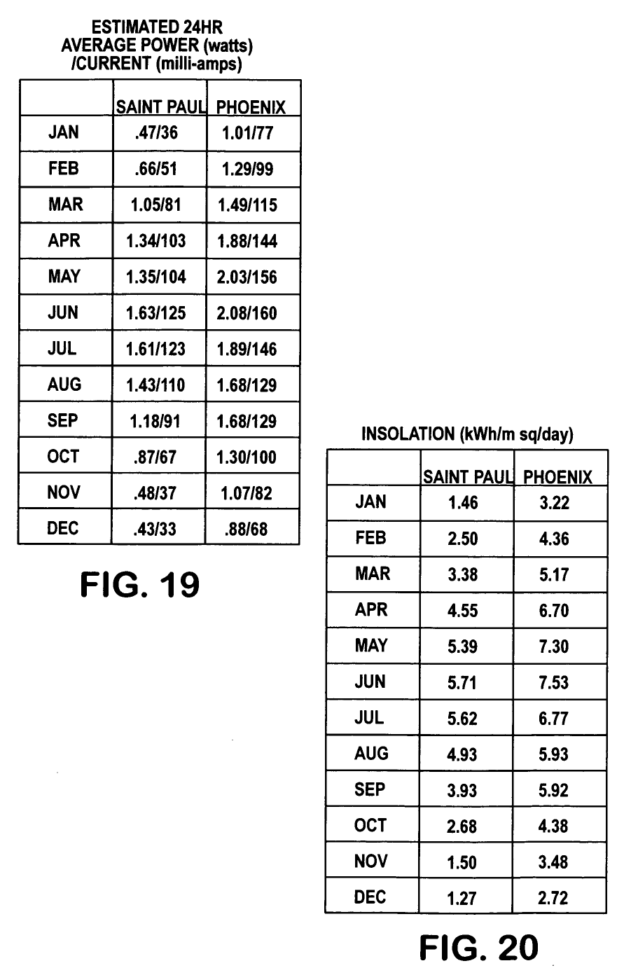

Because the two arrays 72, 74 are mounted in approximately opposite directions, one array will typically receive direct sunlight, and the other, indirect sunlight. For the array receiving indirect sunlight, an estimated 0.8 kw-hr day will be used. For the array receiving direct sunlight, the chart in FIG. 20 is used. A de-rating factor of 0.74 is used for the Saint Paul location in the winter months to account for poor orientation of the array. The resulting calculations produce the estimates for power and current output shown in FIG. 19.

The inventive systems can supply efficient power over this wide range of solar inputs and provide the power requirements for certain devices under various conditions as explained earlier. When a system has multiple arrays, a configuration like configuration 38 in FIG. 1 can selectively connect the arrays to optimize the system for the available solar energy for the particular power requirements of the vehicle electrical system (low power on cloudy days, high power on sunny days).

FIGS. 2, 3A, and 4A show that array output is substantially different during a cloudy period of a day from that of a sunny period. Although the output is substantially less during cloud cover, the power needs of the loads like those shown in FIG. 1 for example are also typically lower, and so array power can still provide a substantial portion of those power needs.

To extract such power from a fixed configuration array, the array would need to be sized such that the vehicle system voltage is low (i.e. 60%) when compared with the array's peak voltage. That however is not the optimal configuration during a sunny condition when the vehicle is requesting higher power for cab cooling. During sunny conditions, the optimal configuration will be higher (i.e. 80% of peak voltage). Therefore, a fixed array cannot operate efficiently for these diverse conditions without some type of output conversion or array manipulation.

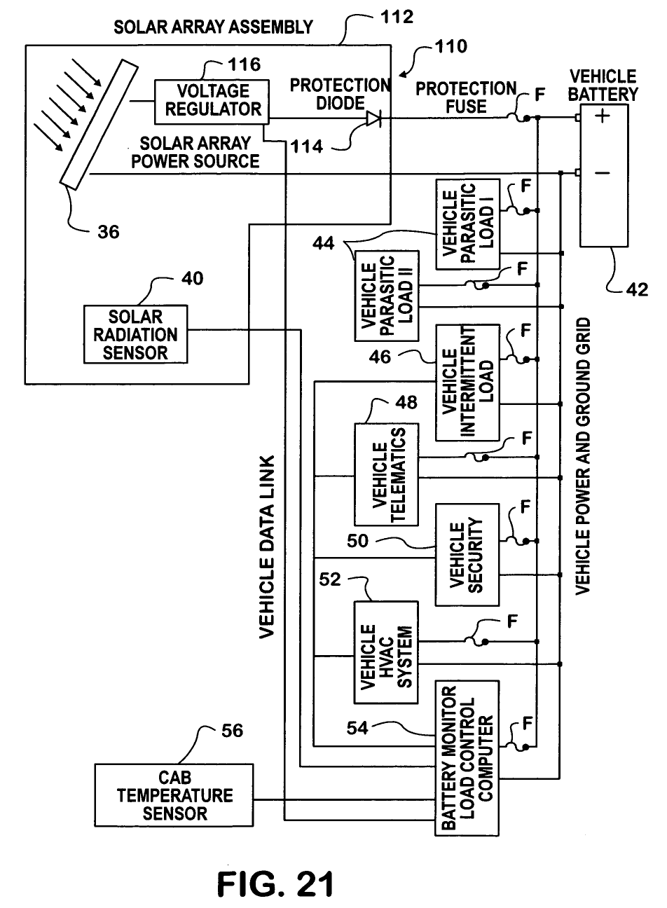

FIG. 21 discloses a further embodiment of energy conversion system 110. The same elements that were described in connection with FIG. 1 are designated by the same reference numerals in FIG. 21. This system comprises a single array 36 whose output is voltage regulated by a voltage regulator 116 controlled by computer 54 to prevent battery overcharging by the array. A protection diode 114 connects the regulated voltage output to grid 58.

While a presently preferred embodiment of the invention has been illustrated and described, it should be appreciated that principles of the invention apply to all embodiments falling within the scope of the following claims.

What is claimed is:

1. An energy conversion system that is on-board a mobile vehicle for converting incident solar radiation into electricity for use in an electrical system of the vehicle, the energy conversion system comprising:
multiple solar cell arrays, each of which has a face oriented differently relative to the direction from which solar radiation is incident on the vehicle and comprises a characteristic voltage/current output correlated with the intensity of incident solar radiation, for converting the incident solar radiation into electricity;
and a processor for processing data related to the voltage/current output from each array as it is converting solar radiation into electricity for selectively connecting the arrays in configurations correlated with the intensity of solar radiation incident on the vehicle.

2. An energy conversion system as set forth in claim 1 wherein a first array is disposed in a right-hand rearview mirror assembly of the vehicle, and a second array is disposed in a left hand rearview mirror assembly of the vehicle.

3. An energy conversion system as set forth in claim 2 wherein the mirror assemblies comprise respective mirrored surfaces for providing a driver of the vehicle with a field of view rearward of the vehicle, and the respective array faces in a direction that is generally opposite that of the direction that the corresponding mirrored surface faces.

4. An energy conversion system as set forth in claim 3 wherein the direction in which each of the respective arrays faces is oblique to an imaginary vertical line passing through the respective array, oblique to an imaginary horizontal line passing through the respective array parallel to the fore-aft direction in the vehicle, and oblique to an imaginary horizontal line passing through the respective array perpendicular to the fore-aft direction in the vehicle.

5. An energy conversion system as set forth in claim 3 wherein the respective arrays are covered by respective protective lenses that are transparent to solar radiation, and each mirror assembly comprises an electric heater that when energized by electricity can heat the respective lens.

6. An energy conversion system as set forth in claim 1 including a sensor for sensing the intensity of solar radiation incident on the vehicle and providing corresponding data to the processor.

7. An energy conversion system as set forth in claim 6 wherein the processor is arranged to process data from the sensor and data that distinguishes a lower range of intensities of solar radiation from an upper range of intensities to cause the arrays to be connected in parallel when the result of the processing discloses that the intensity of incident solar radiation is in the upper range and in series when the result of the processing discloses that the intensity of incident solar radiation is in the lower range.

8. A motor vehicle comprising:
an electrical system comprising one or more batteries providing electricity;
an engine that is turned on and off by operation of a switch in the electrical system;
an on-board energy conversion system for converting incident solar radiation into electricity for use in the electrical system, the energy conversion system comprising one or more solar cell arrays collectively providing a characteristic voltage/current output correlated with the intensity of incident solar radiation for converting the incident solar radiation into electricity;
one or more loads in the electrical system that draw electricity when the switch is off;
wherein the one or more arrays are configured to provide an open circuit voltage for overcoming the charge acceptance voltage of the one or more batteries when the intensity of solar radiation incident on the one or more arrays is greater than a defined minimum intensity but less than a maximum intensity, and for delivering, with the switch off, sufficient electric current for the one or more loads when the intensity of solar radiation incident on the one or more arrays is greater than the defined minimum.

9. A motor vehicle as set forth in claim 8 wherein the defined minimum intensity is approximately 100 watts per square meter, and for intensities exceeding the minimum, the one or more arrays can deliver at least approximately 50 milliamps of current.

10. A motor vehicle as set forth in claim 9 wherein the one or more loads comprise a telemetric system for wirelessly transmitting data related to the vehicle.

11. A motor vehicle as set forth in claim 9 wherein the one or more loads comprise a security system for signaling attempted unauthorized access to the vehicle.

12. A motor vehicle as set forth in claim 9 wherein the one or more loads comprise a ventilation system for ventilating an interior of the vehicle.

13. A motor vehicle as set forth in claim 8 including a voltage regulator for regulating the voltage output of the one or more arrays.

14. An energy conversion system that is on-board a mobile vehicle for converting solar radiation into electric power for use in an electrical system of the vehicle that comprises one or more batteries providing electricity for the electrical system, the energy conversion system comprising:
a solar cell array that converts incident solar radiation into electricity, that is disposed in an outside rearview mirror assembly of the vehicle, and that is electrically connected to the electrical system to supply electricity to the electrical system for aiding in maintaining state of charge of the one or more batteries.

15. An energy conversion system as set forth in claim 14 wherein the mirror assembly comprises a mirrored surface for providing a driver of the vehicle with a field of view rearward of the vehicle and the array is disposed in the rearview mirror assembly to face in a direction that is generally opposite that of the direction that the mirrored surface faces.

16. An energy conversion system as set forth in claim 15 wherein the direction in which the array faces is oblique to an imaginary vertical line passing through the array, oblique to an imaginary horizontal line passing through the array parallel to the fore-aft direction in the vehicle, and oblique to an imaginary horizontal line passing through the array perpendicular to the fore-aft direction in the vehicle.

17. An energy conversion system as set forth in claim 16 wherein the array is covered by a protective lens that is transparent to solar radiation, and further including an electric heater that when energized by electricity can heat the lens.

18. An outside rearview mirror assembly for a motor vehicle comprising:
a mirrored surface for providing a driver of the vehicle with a field of view rearward of the vehicle; a solar cell array for converting incident solar radiation into electricity; and a connection for connecting the array to supply electricity to an electrical system of the vehicle.

19. An outside rearview mirror assembly as set forth in claim 18 further including a protective lens that is transparent to solar radiation covering the array, and further including an electric heater that when energized by electricity can heat the lens.

20. An outside rearview mirror assembly as set forth in claim 18 wherein the array is disposed in the assembly to face in a direction that is generally opposite that of the direction that the mirrored surface faces.

21. An energy conversion method on-board a mobile vehicle for converting incident solar radiation into electricity for use in an electrical system of the vehicle, the method comprising:
processing data related to the voltage/current output of multiple solar cell arrays, each of which has a face oriented differently relative to the direction from which solar radiation is incident on the vehicle and comprises a characteristic voltage/current output correlated with the intensity of incident solar radiation, for converting the incident solar radiation into electricity; and selectively connecting the arrays in configurations correlated with the intensity of solar radiation incident on the vehicle.

22. An energy conversion method as set forth in claim 21 including processing data from a sensor that discloses intensity of solar radiation incident on the vehicle for distinguishing a lower range of intensities of solar radiation from an upper range of intensities, and causing the arrays to be connected in parallel when the result of the processing discloses that the intensity of incident solar radiation is in the upper range and in series when the result of the processing discloses that the intensity of incident solar radiation is in the lower range.
